(19) United States
(12) Patent Application Publication
(10) Pub. No.: US 2014/0085245 A1
(43) Pub. Date: Mar. 27, 2014

(54) DISPLAY INTEGRATED CAMERA ARRAY

(71) Applicant: Amazon Technologies, Inc., (US)

(72) Inventors: Leo B. Baldwin, San Jose, CA (US); Kenneth M. Karakotsios, San Jose, CA (US); Tomer Moscovich, San Francisco, CA (US); Isaac S. Noble, Soquel, CA (US)

(73) Assignee: Amazon Technologies, Inc., Reno, NV (US)

(21) Appl. No.: 13/624,378

(22) Filed: Sep. 21, 2012

(51) Int. Cl. G06F 3/0488; G01J 1/42; G01J 5/20

(52) U.S. Cl. CPC G06F 3/0488; G01J 5/20; G01J 1/4228
USPC 345/174; 250/338.4; 250/206.1; 250/341.7

(57) ABSTRACT

Motions or gestures can provide input to an electronic device by capturing images of a feature used to provide the motions or gestures, then analyzing the images. Conventional cameras have a limited field of view, creating a “dead zone” near the device that is outside the field of view. Various embodiments utilize an array of detectors positioned behind a display screen that are configured to operate as a large, low resolution camera. The array can resolve objects within a distance of the device sufficient to cover at least a portion of the dead zone. In some embodiments the device can include one or more infrared (IR) emitters to emit IR light that can be reflected by an object in the dead zone and detected by the detectors. The use of multiple emitters at different locations enables at least some depth information to be determined from the array images.

### BACKGROUND

As computing devices offer increased processing capacity and functionality, users are able to provide input in an expanding variety of ways. For example, a user might be able to control a computing device by performing a motion or gesture at a distance from the computing device, where that gesture is performed using a hand or finger of the user. For certain devices, the gesture is determined using images captured by a camera that is able to view the user, enabling the device to determine motion performed by that user. In some cases, however, at least a portion of the user will not be within the field of view of the camera, which can prevent the device from successfully determining the motion or gesture being performed. While capacitive touch approaches can sense the presence of a finger very close to a touch screen of the device, there is still a large dead zone outside the field of view of the camera that prevents the location or movement of a finger of the user from being determined.

### BRIEF DESCRIPTION OF THE DRAWINGS

Various embodiments in accordance with the present disclosure will be described with reference to the drawings, in which:

FIG. 1 illustrates an example situation wherein a user is interacting with a computing device in accordance with various embodiments;

FIGS. 2(a), 2(b), and 2(c) illustrate views of an example camera array that can be utilized in accordance with various embodiments;

FIGS. 3(a), 3(b), 3(c), 3(d), 3(e), and 3(f) illustrate example images that can be captured using a camera array in accordance with various embodiments;

FIGS. 4(a) and 4(b) illustrate portions of an example process for operating a camera array in accordance with various embodiments;

FIGS. 5(a), 5(b), 5(c), and 5(d) illustrate example approaches to determining feature location using a combination of camera elements that can be utilized in accordance with various embodiments;

FIG. 6 illustrates an example device that can be utilized in accordance with various embodiments;

FIG. 7 illustrates an example set of components that can be utilized in a device such as that illustrated in FIG. 6; and

FIG. 8 illustrates an example an environment in which various embodiments can be implemented.

### DETAILED DESCRIPTION

Systems and methods in accordance with various embodiments of the present disclosure may overcome one or more of the aforementioned and other deficiencies experienced in conventional approaches to providing input to an electronic device. In particular, approaches discussed herein utilize a combination of camera elements to capture images and/or video of a feature of a user (or object being held by the user, etc.) for purposes of determining motions, gestures, or other such actions performed by the user. In at least some embodiments, one or more conventional cameras can be used to capture images of a feature of a user, such as a user's fingertip, or an object held by the user, while the feature (or object) is in a field of view of at least one camera of the device. The device also can include a relatively low-resolution camera array, which can be integrated with, or positioned proximate to, a display screen (or other at least semi-transparent element) of the device, such that the elements of the array can capture light (e.g., ambient or IR) passing through the display screen.

In at least some embodiments, each element of the array is a separate light or radiation detector, such as a photodiode. The individual detectors can be positioned “behind” the display screen in at least some embodiments, and in some embodiments can be positioned behind an IR-transmissive sheet or other such element capable of preventing ambient light from being detected by the elements, enabling the camera array to operate even when the display screen is actively displaying content. One or more illumination elements can be configured to transmit light to be reflected from a nearby object and detected by the array. Since the detectors do not have lenses in at least some embodiments, the array will only be able to capture discernible images over a range of distance from the array. The emitters can emit IR that can pass through the IR transmissive sheet and enable determination of location of an object near the screen independent of operation of the screen. In at least some embodiments images can be captured with different directions of illumination from different IR emitters, in order to obtain depth information useful in determining an orientation or other aspect of the feature being detected.

Many other alternatives and variations are described and suggested below in relation to at least some of the various embodiments.

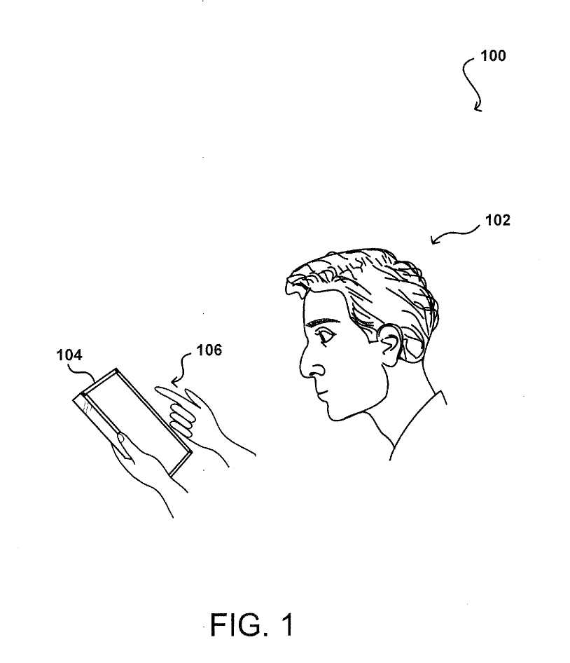

FIG. 1 illustrates an example environment 100 in which aspects of various embodiments can be implemented. In this example, a user 102 is attempting to provide gesture input to a computing device 104 using the user's finger 106. Although a portable computing device (e.g., an electronic book reader, smart phone, or tablet computer) is shown, it should be understood that any electronic device capable of receiving, determining, and/or processing input can be used in accordance with various embodiments discussed herein, where the devices can include, for example, desktop computers, notebook computers, personal data assistants, video gaming consoles, television set top boxes, smart televisions, and portable media players, among others.

In this example, the computing device 104 can include one or more cameras 108 configured to capture image information including a view of the user's finger 106, which can be analyzed by an application executing on the computing device to determine a relative location of the finger with respect to the computing device 104. The image information can be still image or video information captured using ambient or infrared light, among other such options. Further, any appropriate number of cameras of the same or different types can be used within the scope of the various embodiments. The application can determine the position of the finger (or another such object), and can track the position of the finger over time by analyzing the captured image information, in order to allow for motion and/or gesture input to the device. For example, the user can move the finger up and down to adjust a volume, move the finger in a plane to control a virtual cursor, and the like.

Relying on camera information can have certain drawbacks, however, as each camera will generally have a limited field of view, even for wide angle lenses (i.e., with a capture angle on the order of about 120 degrees, for example). Even fisheye or other wide-angle lenses have limited fields of view, or at least provide somewhat distorted images near an edge of a field of view. Accordingly, there will generally be one or more dead zones around the computing device where an object might fall outside the field of view of any of the cameras. Until the fingertip enters the field of view of at least one camera, the device cannot locate the fingertip in images captured from any of the cameras, and thus cannot determine or track motion of the feature.

Approaches in accordance with various embodiments can account for at least some of the dead zone between and/or outside the field of view of one or more cameras on a computing device by utilizing a camera array (or sensor array) positioned to capture light (e.g., ambient or IR) passing through a display screen or other such element of the device. The camera array can be integrated with, or otherwise positioned with respect to, a display element in accordance with various embodiments. In devices with multiple display elements, there might be multiple camera arrays utilized to detect motions, gestures, hovers, or other actions near those elements that might be outside the field of view of at least one conventional camera on the device.

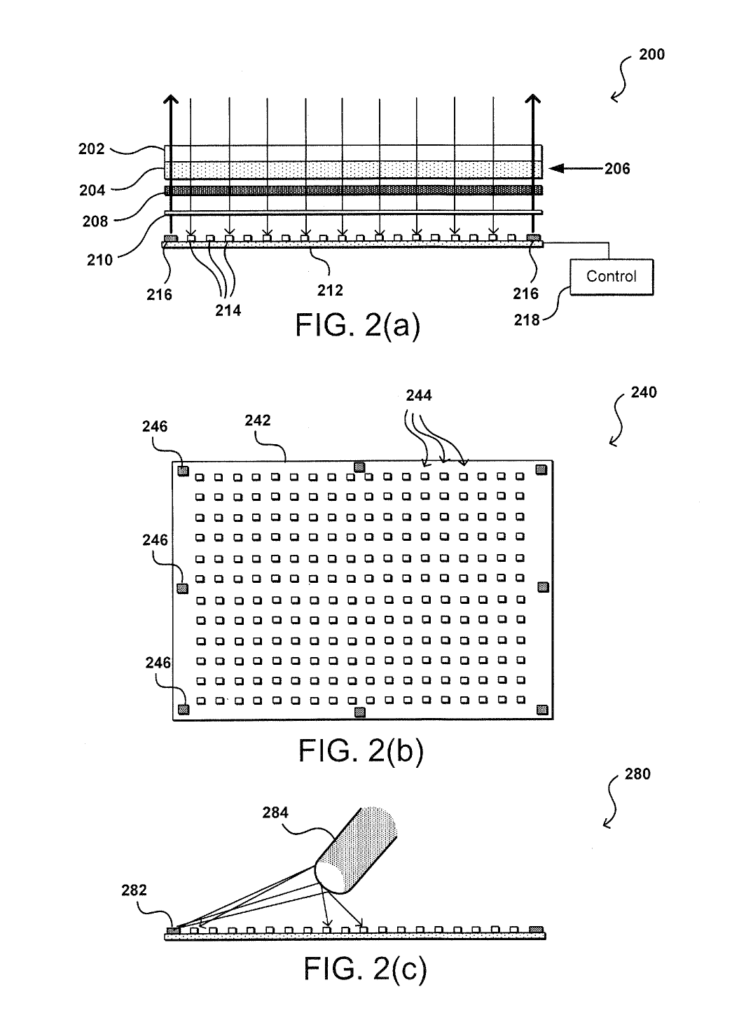

FIG. 2(a) illustrates a cross-sectional view 200 of an example camera array that can be utilized in accordance with various embodiments. In this example the array is positioned “behind” a display screen, which can include at least display layer 202 that can be at least semi-transparent, based at least in part upon the type of display screen (e.g., LCD or OLED). Depending on the type of display, various other layers and components can be utilized as well as known or used for such purposes. For example, an LCD display might include a backlight layer 204 for receiving and directing light 206 (from a source on the device such as at least one LED) through the display layer 202 in order to generate an image on the display screen. The camera array in this example includes an array of detectors 214, such as photodiodes, positioned on a printed circuit board (PCB), flex circuit, or other such (substantially flat or planar) substrate 212, with the detectors positioned on the side towards the display screen in order to be able to capture light incident on, and passing through, the display layer 202 from outside the computing device. It should be understood, however, that various types of single- or multi-value light or radiation sensors could be used as well within the scope of the various embodiments. Further, other layers of the display can function as a substrate, or support for various emitters and/or detectors, such that a separate substrate layer is not used in some embodiments. In displays with a backlight layer 206, the detectors can be positioned “behind” the backlight layer 206 with respect to the display layer 202, as the circuitry, lines, and/or other components on (or in) the substrate 212 generally will not be transparent in at least some embodiments, for factors that may include complexity and cost, among others.

In this example, the detectors 214 are positioned at regular intervals in two dimensions, spaced a relatively fixed amount apart, although other configurations can be used as well. The spacing can be determined based at least in part upon the size of each detector, the size of the display screen, and/or the desired resolution of the camera array, among other such factors. In at least some embodiments none of the detectors will contain a focusing lens, such that the camera array will effectively function as a near-field camera. The lack of lenses can cause each detector to directly sense light returned from the finger, which in at least some embodiments can only be discerned for fingers or other objects within a relatively short distance from the screen, such as within a range of less than one or two inches. Anything beyond that range may be too blurry to be decipherable, but since the dead zone for conventional camera configurations can be on the order of about two inches from the display screen or less, such range can be sufficient to at least determine the approximate location of a feature within the dead zone.

Such an approach has advantages, as the lack of lenses allows the camera array to be relatively thin, which can be desirable for devices with limited space such as portable computing devices. Further, the array can be relatively inexpensive, and does not require optical alignment that might otherwise be required when including lenses with the array. Since the distance that the camera array is intended to cover is relatively close to the device, such as in the camera dead zone as discussed above, there may be little advantage to adding lenses when the position of the fingertip (or another such object) can be determined without such lenses.

In some embodiments, such as for OLED displays that are substantially transparent, the detectors can capture ambient (or other) light passing through the display layer. For display devices such as LCD displays, however, the detectors might need to be timed to capture images between refresh times of the display, in order to prevent the detectors from being saturated, or at least the captured image data from being dominated or contaminated by the light from the image being rendered on the display screen. At least some display screen assemblies include an at least partially opaque backplane layer 208, which can prevent light from being directed into the device and/or cause the display screen to appear black (or another appropriate color) when the display is not displaying content. If a backplane layer 208 is used with the display screen, the detectors might be positioned to capture light passing through holes or openings in the backplane, or the detectors might be at least partially passed through the backplane layer, among other such options.

In the example of FIG. 2(a), the detectors are configured to capture (at least) infrared (IR) light passing through the display layer 202. In at least some embodiments, one or more IR emitters 216 (e.g., IR LEDs) can be positioned on the device to cause IR light to be emitted, which can be reflected by any object in the dead zone such that at least a portion of the reflected IR light can be detected by the photodiodes 214. While any appropriate number of IR emitters can be positioned at any appropriate location on the device, in this example there are multiple emitters 216 positioned on the substrate 212 so as to direct light “up” through the display layer (in the figure), with the reflected light being directed back “down” through the layer. It should be understood that directions such as “up” and “down” are used for ease of explanation and should not be interpreted as required directions unless otherwise stated for specific embodiments. Further, as mentioned, one or more emitters can be positioned away from the substrate in at least some embodiments, such as interspersed between the light sources for a backlight of the display, among other such options. The emitters and detectors can be controlled and/or operated using control circuitry 218 and/or components that can be positioned at an edge of the substrate 212, for example, in order to time the emission of IR and the detection by the detectors. The control circuitry can include one or more processors for collecting and/or analyzing the collected image data from the detectors, or can pass the data on to at least one other processor (not shown) of the device. Discrete read-out circuitry can be used that can go through a row/column selection process do address each detector, as the limited number can enable a serial reading process to be performed relatively quickly, although in some approaches the reading can be performed at least partially in parallel.

As mentioned, a display screen might have a backplane 208 or other at least partially opaque layer (e.g., a black piece of plastic or similar material) positioned “behind” the display layer 202. In at least some embodiments, this layer might be substantially opaque over the visible spectrum, but might allow for transmission of at least a portion of the IR spectrum. Accordingly, the emitters 216 and detectors 214 can be positioned behind the backplane and configured to emit and capture IR, respectively, that passes through the backplane 208. An advantage to being able to utilize IR passing through the backplane layer is that the detection can occur at any time, independent of the operation of the display screen. Further, ambient light incident on the device will not be able to interfere with the light detected by the detectors, such as where the detectors might not be dedicated IR detectors but might be able to capture light over a wide range of wavelengths, including the visible and IR spectrums. Further, such positioning of the camera array can prevent the array from being visible by a user when the display is not displaying content. For embodiments without a backplane or where the emitters and/or detectors are positioned at openings in the backplane, the emitters and detectors can be substantially black and surrounded by black components, but might still be at least somewhat visible to a user of the device. In some embodiments a diffuse surface can be positioned above the backplane in order to reduce the appearance of the detectors to a user of the device. In other embodiments, the detectors can be made to appear white by coating a lens of the detectors, such that the detectors do not appear as dark spots with respect to an otherwise white backlight in at least some embodiments.

In at least some embodiments the emitters also will not have lenses, such that the emitters can be relatively broad angle as well. In order to at least partially control the direction of light, a thin film waveguide layer 210 can be used that can be positioned between the display layer 202 and the emitters 216, whether positioned on a display layer, as part of a backplane, or in another appropriate location. The thin film can have a plurality of channels or diffractive features configured to limit the emission angle for the emitters. Such an approach can further help to discriminate light reflected from different emitters. Other films might include light pipes or other features that can direct light toward the middle of the dead zone, beyond an edge of the display, etc. The ability to focus and direct the light can also help to increase the efficiency of the device.

FIG. 2(b) illustrates an example top view 240 of a portion of a camera array assembly that can be utilized in accordance with various embodiments. In this example, an array of photodiodes 244 is spaced at regular intervals (e.g., on the order of about 1-2 millimeters apart) across a majority of the area of the flex circuit substrate 242, which is comparable in size to that of the display screen by which the array will be positioned. It should be understood that the array can be positioned at one or more smaller regions of the substrate, can be positioned up to the edges, or can be otherwise arranged. Further, the spacing may be irregular or in a determined pattern, and there can be different numbers or densities of photodiodes as discussed elsewhere herein. In one example, there are on the order of thirty, forty, or eighty diodes in one or both directions, while in other examples there are hundreds to thousands of detectors in an array. As conventional cameras typically include millions of pixels, the camera array can be considered to be relatively low resolution. In this example there are a number of emitters 246 about an edge of the substrate 242. It should be understood that any number of emitters (e.g., one or more IR LED's) can be used in various embodiments, and the emitters can be positioned at other appropriate locations, such as at the four corners of the substrate, interspersed between at least a portion of the detectors, etc. In some embodiments, placing the emitters about an edge of the substrate can allow for a relatively uniform illumination of a feature in the dead zone or otherwise sufficiently near the camera array. In embodiments including a backlight layer, the backlight can be segmented into regions that are activated in sequence. The detectors for a region can capture light when the corresponding region is not activated, such that the detectors of the region are not saturated.

At least some embodiments can take advantage of the spread arrangement of emitters to emit IR from different directions at different times, which can cause different portions of the feature to be illuminated at different times. Such information can be used to obtain depth, shape, and other such information that may not otherwise be obtainable with the near-field camera approach supported by the camera array. For example, consider the situation 280 of FIG. 2(c). Light from one or more emitters 282 on a side or corner of the substrate is activated, which causes a region of a finger 284 to be illuminated that is toward the direction of the activated emitter(s). As should be apparent from the figure, the region that is illuminated is different from the region that would be illuminated if an emitter 286 on the other side or another corner was emitting at the same time, or if the emitter 286 was emitting by itself. Further, the detectors receiving reflected light will be different for each direction. While features may not be able to be distinguished from a near-field image, the ability to illuminate different regions of an object in different images can allow additional information to be obtained about that object.

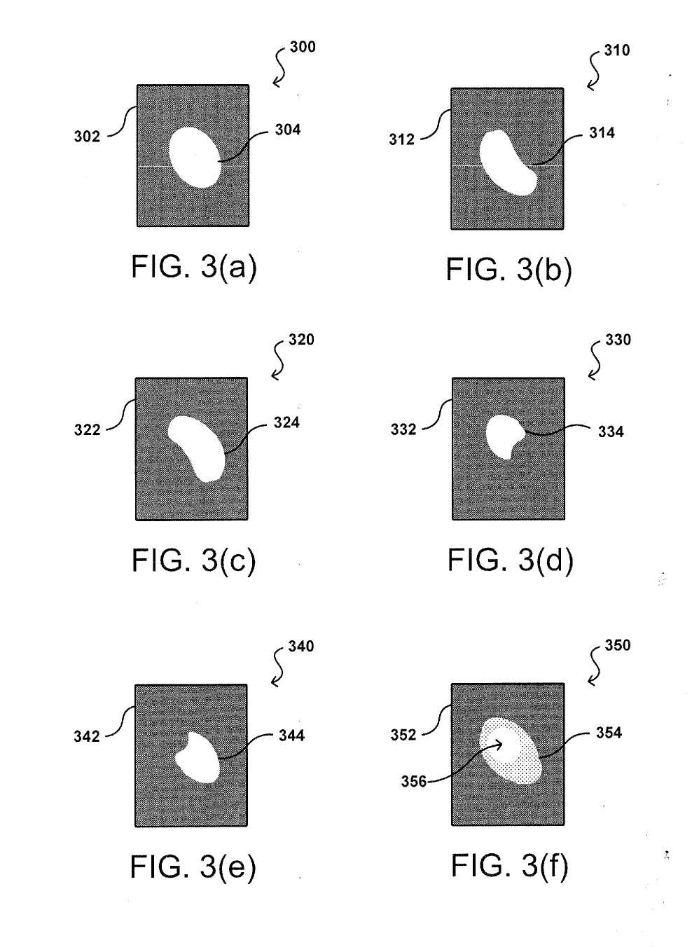

As an example, FIG. 3(a) illustrates a view 300 of an example image 302 that might be obtained when all the emitters are activated. As should be apparent in light of the present disclosure, such an image is generated by obtaining the information from each detector and assembling that information into a single image based at least in part upon the relative location of each detector. As illustrated, a region 304 of illumination is contained in the image, which corresponds to the location of an object near the camera array. While the region 304 can be useful in determining the relative location of the object, there is little additional information available due at least in part to the limitations of a near-field camera as discussed above. In the view 310 of FIG. 3(b), however, the image 312 illustrated shows a slightly different region 314 corresponding to the object, where only a portion of the object was illuminated with respect to the image of FIG. 3(a), as an emitter on a specified side or corner of the array was used to illuminate the object. The image in FIG. 3(b) can correspond to a situation where the illumination came from an emitter on the lower left corner of the display (based at least in part upon the figure orientation). Similarly, the views 320, 330, 340 of the object in FIGS. 3(c), 3(d), and 3(e) illustrate regions 324, 334, 344 of the object that were illuminated by emitters on the upper right, upper left, and lower right of the array, respectively. As illustrated, even though each view contains little to no depth information, each view contains a slightly different shape representing the object, based at least in part upon the direction from which the object was illuminated. These images can be combined, whether through mapping and pixel value addition or another such process, to obtain an image 352 such as that illustrated in the view 350 of FIG. 3(f). In the image 352, a bright central region 356 is illustrated that corresponds to a portion of the object that was illuminated by most or all of the emitters, and thus appeared as a bright region in each of the captured images. There also is a region of less intensity 354 outside the bright central region 356. Although shown as a single lower intensity, it should be understood that variations in intensity can occur within, and between, image portions in accordance with the various embodiments. The region of lower intensity corresponds to one or more portions of the object that were illuminated by less than all of the emitters, or at least one emitter. The fewer images a region appeared in, the less intense that area may appear in the resulting combined image 352. These differences in intensity can provide some spatial information as to the shape and/or orientation of the object that was not available in any of the individual images. For example, from FIG. 3(f) it can be determined that the object might be an elongated object such as a finger, with the bright region 356 corresponding substantially to the fingertip. From the shape of the lower intensity region 354, it can be determined that the finger is likely coming from the lower right of the screen (in the figure). In at least some embodiments, the relative shape of the lower intensity region to the region of brighter intensity also can be used to estimate an angle of the finger, as a finger positioned orthogonal to the screen will tend to be round in the image and a finger positioned substantially parallel to the screen will have a very elongated shape in the image, with differences in angle there between having differences in the amount of relative elongation with respect to the bright central region. Thus, the combined image 352 can be used to determine not only where the fingertip is located, but can help to estimate where the finger is pointing based on the apparent shape of the object in the combined image.

Further, the size of the bright central region 356 and/or less intense outer region 354 in the image can be used to estimate a distance of the object, as objects closer to the detectors will appear larger in the combined image. By knowing the approximate diameter (or other measure) of a fingertip of the user, for example, the device can estimate the distance to the fingertip based on the apparent size in the image. The distance to the object can be used with the angle information obtained from the combined image to more accurately estimate where the object is pointing, in order to more accurately accept input to the device. Various other type of information can be determined and/or utilized as well within the scope of the various embodiments. Further, if at least a portion of the hand or finger is visible in the field of view of at least one of the conventional, higher resolution cameras, the position information from the conventional camera view can be used with the information from the low resolution, large format camera array to more accurately determine the approximate location of the fingertip and orientation of the finger, or other such object.

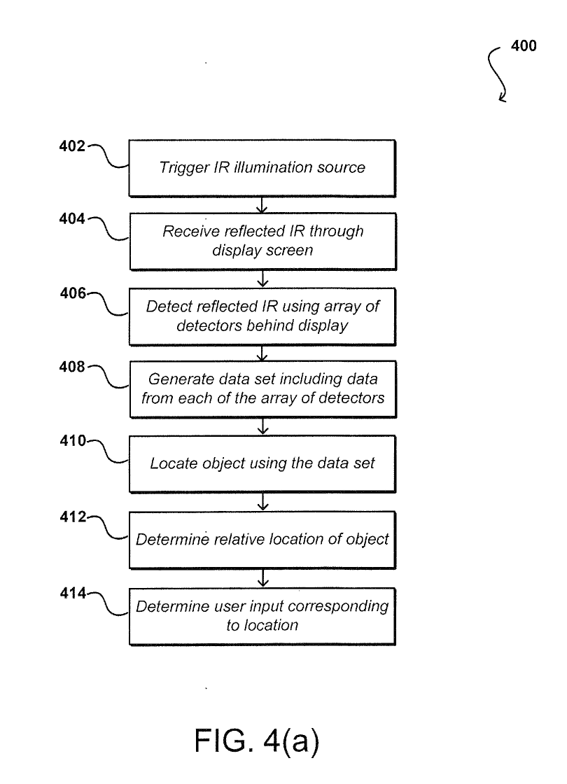

FIG. 4(a) illustrates an example process 400 that can be utilized in accordance with various embodiments. It should be understood, however, that there can be additional, fewer, or alternative steps performed in similar or alternative orders, or in parallel, within the scope of the various embodiments unless otherwise stated. In this example, an infrared illumination source is triggered 402, or otherwise activated, on a computing device. As discussed, the source can be located on a circuit or substrate in common with an array of detectors, and can be configured to direct light through a display screen of the computing device. Infrared light reflected from a nearby object can be received 404 back through the display screen and detected 406 using at least a portion of the array of detectors. As mentioned, each detector can be a photodiode or other single-pixel or single value-detector, producing at least a single intensity value at the respective position. A data set (or image in some embodiments) can be generated 408 using the intensity values of the detectors and the relative positions of the detectors. The data set can be analyzed to locate 410 an object, such as by locating a region of relatively high intensity, pixel, or color values. The relative location of the object to the device can be determined 412 based at least in part upon the location of the high intensity region as determined by the data set. User input corresponding to the location can be determined 414 and provided to an appropriate location, such as an application executing on the device.

FIG. 4(b) illustrates an additional portion 420 of such a process that can be utilized when multiple illumination sources are present on the computing device. In this example portion, each of the illumination sources to be used for the object location determination is triggered 422 in sequence. As mentioned, this can include illumination from each of four corners or sides of the display region, among other such options. An illumination source can include a single emitter or group of emitters. For each illumination element triggered in the sequence, steps such as steps 404-408 can be performed to generate a respective data set using light captured by the plurality of detectors. A combined data set then can be created 426 using the individual data sets generated for each illumination in the sequence. As discussed, the combined data set will include regions with different intensity based at least in part upon the number of images in which light reflected from that object was captured by the same detectors. The relative location of the object can be determined 428 by locating a region of highest intensity in the combined data set, as discussed with respect to step 412. Using the combined data set, however, the intensity variations can also be analyzed 430 in order to determine an approximate orientation of the object. User input to be provided then can be determined 432 using not only the determined location of the object, but also the orientation. As discussed, distance estimates can also be made in at least some embodiments to assist with the input determinations.

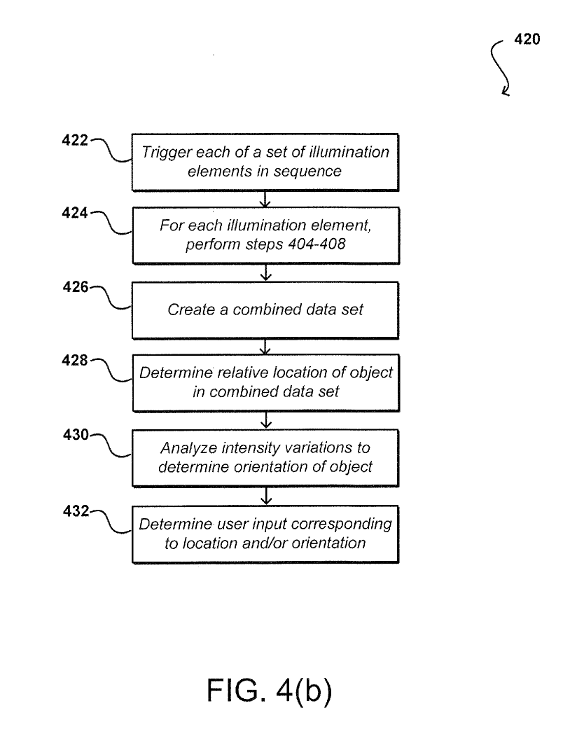

As mentioned, the information from the camera array can be used to supplement the information obtained from conventional cameras, or at least higher resolution cameras, elsewhere on the device, such as to compensate for the dead zone between fields of view of those cameras. FIGS. 5(a), (b), (c), and (d) illustrate one example approach to determining a relative distance and/or location of at least one feature of a user that can be utilized in accordance with various embodiments. In this example, input can be provided to a computing device 502 by monitoring the position of the user's fingertip 504 with respect to the device, although various other features can be used as well as discussed and suggested elsewhere herein. In some embodiments, a single camera can be used to capture image information including the user's fingertip, where the relative location can be determined in two dimensions from the position of the fingertip in the image and the distance determined by the relative size of the fingertip in the image. In other embodiments, a distance detector or other such sensor can be used to provide the distance information. The illustrated computing device 502 in this example instead includes at least two different image capture elements 506, 508 positioned on the device with a sufficient separation such that the device can utilize stereoscopic imaging (or another such approach) to determine a relative position of one or more features with respect to the device in three dimensions. Although two cameras are illustrated near a top and bottom of the device in this example, it should be understood that there can be additional or alternative imaging elements of the same or a different type at various other locations on the device within the scope of the various embodiments. Further, it should be understood that terms such as “top” and “upper” are used for clarity of explanation and are not intended to require specific orientations unless otherwise stated. In this example, the upper camera 506 is able to see the fingertip 504 of the user as long as that feature is within a field of view 510 of the upper camera 506 and there are no obstructions between the upper camera and those features. If software executing on the computing device (or otherwise in communication with the computing device) is able to determine information such as the angular field of view of the camera, the zoom level at which the information is currently being captured, and any other such relevant information, the software can determine an approximate direction 514 of the fingertip with respect to the upper camera. In some embodiments, methods such as ultrasonic detection, feature size analysis, luminance analysis through active illumination, or other such distance measurement approaches can be used to assist with position determination as well.

In this example, a second camera is used to assist with location determination as well as to enable distance determinations through stereoscopic imaging. The lower camera 508 in FIG. 5(a) is also able to image the fingertip 504 as long as the feature is at least partially within the field of view 512 of the lower camera 508. Using a similar process to that described above, appropriate software can analyze the image information captured by the lower camera to determine an approximate direction 516 to the user's fingertip. The direction can be determined, in at least some embodiments, by looking at a distance from a center (or other) point of the image and comparing that to the angular measure of the field of view of the camera. For example, a feature in the middle of a captured image is likely directly in front of the respective capture element. If the feature is at the very edge of the image, then the feature is likely at a forty-five degree angle from a vector orthogonal to the image plane of the capture element. Positions between the edge and the center correspond to intermediate angles as would be apparent to one of ordinary skill in the art, and as known in the art for stereoscopic imaging. Once the direction vectors from at least two image capture elements are determined for a given feature, the intersection point of those vectors can be determined, which corresponds to the approximate relative position in three dimensions of the respective feature.

In some embodiments, information from a single camera can be used to determine the relative distance to a feature of a user. For example, a device can determine the size of a feature (e.g., a finger, hand, pen, or stylus) used to provide input to the device. By monitoring the relative size in the captured image information, the device can estimate the relative distance to the feature. This estimated distance can be used to assist with location determination using a single camera or sensor approach.

Further illustrating such an example approach, FIGS. 5(b) and 5(c) illustrate example images 520, 540 that could be captured of the fingertip using the cameras 506, 508 of FIG. 5(a). In this example, FIG. 5(b) illustrates an example image 520 that could be captured using the upper camera 506 in FIG. 5(a). One or more image analysis algorithms can be used to analyze the image to perform pattern recognition, shape recognition, or another such process to identify a feature of interest, such as the user's fingertip, thumb, hand, or other such feature. Approaches to identifying a feature in an image, such may include feature detection, facial feature extraction, feature recognition, stereo vision sensing, character recognition, attribute estimation, or radial basis function (RBF) analysis approaches, are well known in the art and will not be discussed herein in detail. Upon identifying the feature, here the user's hand 522, at least one point of interest 524, here the tip of the user's index finger, is determined As discussed above, the software can use the location of this point with information about the camera to determine a relative direction to the fingertip. A similar approach can be used with the image 540 captured by the lower camera 508 as illustrated in FIG. 5(c), where the hand 542 is located and a direction to the corresponding point 544 determined As illustrated in FIGS. 5(b) and 5(c), there can be offsets in the relative positions of the features due at least in part to the separation of the cameras. Further, there can be offsets due to the physical locations in three dimensions of the features of interest. By looking for the intersection of the direction vectors to determine the position of the fingertip in three dimensions, a corresponding input can be determined within a determined level of accuracy. If higher accuracy is needed, higher resolution and/or additional elements can be used in various embodiments. Further, any other stereoscopic or similar approach for determining relative positions in three dimensions can be used as well within the scope of the various embodiments.

As can be seen in FIG. 5(a), however, there can be a region near the surface of the screen that falls outside the fields of view of the cameras on the device, which creates a “dead zone” where the location of a fingertip or other feature cannot be determined (at least accurately or quickly) using images captured by the cameras of the device.

FIG. 5(d) illustrates an example configuration 560 wherein the device 562 includes a pair of front-facing cameras 564, 566 each capable of capturing images over a respective field of view. If a fingertip or other feature near a display screen 568 of the device falls within at least one of these fields of view, the device can analyze images or video captured by these cameras to determine the location of the fingertip. In order to account for position in the dead zone outside the fields of view near the display, the device can utilize a camera array positioned behind the display screen, as discussed herein, which can detect position at or near the surface of the display screen. Due to the nature of the detectors not having lenses, the ability to resolve any detail is limited. As discussed, however, the useful range 570 of the camera array can cover at least a portion of the dead zone, and in at least some embodiments will also at least partially overlaps the fields of view. Such an approach enables the location of a fingertip or feature to be detected when that fingertip is within a given distance of the display screen, whether or not the fingertip can be seen by one of the conventional cameras. Such an approach also enables a finger or other object to be tracked as the object passes in and out of the dead zone. Other location detection approaches can be used as well, such as ultrasonic detection, distance detection, optical analysis, and the like.

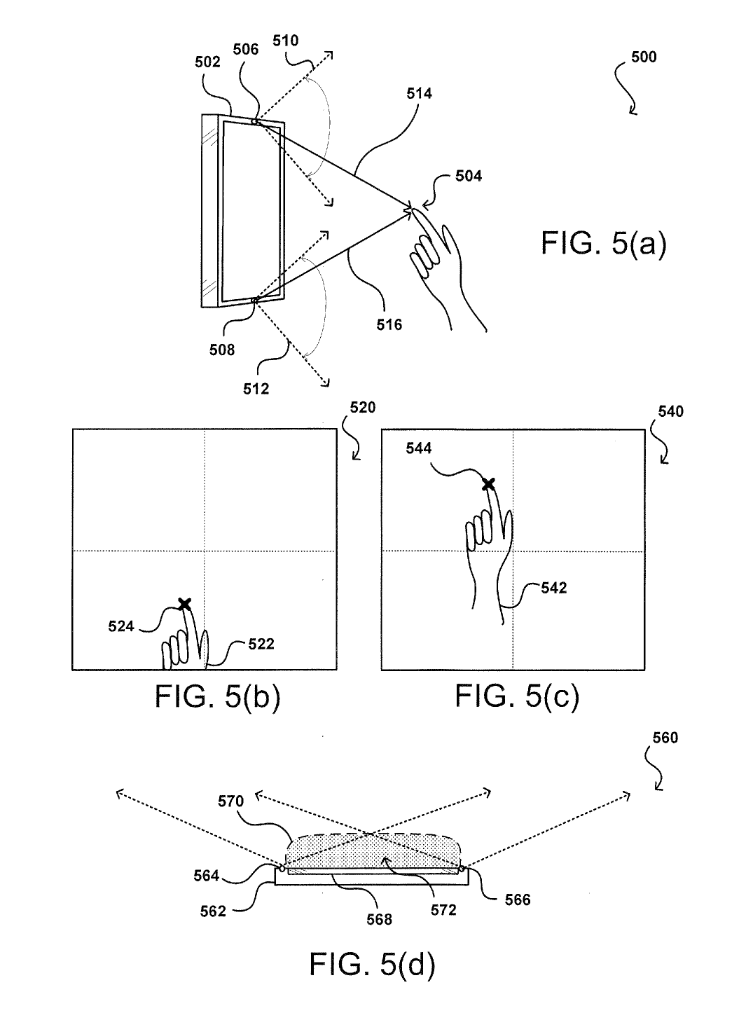

FIG. 6 illustrates an example electronic user device 600 that can be used in accordance with various embodiments. Although a portable computing device (e.g., an electronic book reader or tablet computer) is shown, it should be understood that any electronic device capable of receiving, determining, and/or processing input can be used in accordance with various embodiments discussed herein, where the devices can include, for example, desktop computers, notebook computers, personal data assistants, smart phones, video gaming consoles, television set top boxes, and portable media players. In this example, the computing device 600 has a display screen 602 on the front side, which under normal operation will display information to a user facing the display screen (e.g., on the same side of the computing device as the display screen). The computing device in this example includes at least one conventional camera 604 or other imaging element for capturing still or video image information over at least a field of view of the at least one camera. In some embodiments, the computing device might only contain one imaging element, and in other embodiments the computing device might contain several imaging elements. Each image capture element may be, for example, a camera, a charge-coupled device (CCD), a motion detection sensor, or an infrared sensor, among many other possibilities. If there are multiple image capture elements on the computing device, the image capture elements may be of different types. In some embodiments, at least one imaging element can include at least one wide-angle optical element, such as a fish-eye lens, that enables the camera to capture images over a wide range of angles, such as 180 degrees or more. Further, each image capture element can comprise a digital still camera, configured to capture subsequent frames in rapid succession, or a video camera able to capture streaming video. The device can also include other components to assist with image capture, such as at least one light sensor 606 for determining an amount of ambient light around the device and at least one illumination element 608, such as a white light or colored LED, for providing a source of illumination that can be timed for image capture.

The example computing device 600 also includes at least one microphone 606 or other audio capture device capable of capturing audio data, such as words or commands spoken by a user of the device, music playing near the device, etc. In this example, a microphone is placed on the same side of the device as the display screen, such that the microphone will typically be better able to capture words spoken by a user of the device. The example computing device 600 also includes at least one communications or networking component 612 that can enable the device to communicate wired or wirelessly across at least one network, such as the Internet, a cellular network, a local area network, and the like. In some embodiments, at least a portion of the image processing, analysis, and/or combination can be performed on a server or other component remote from the computing device.

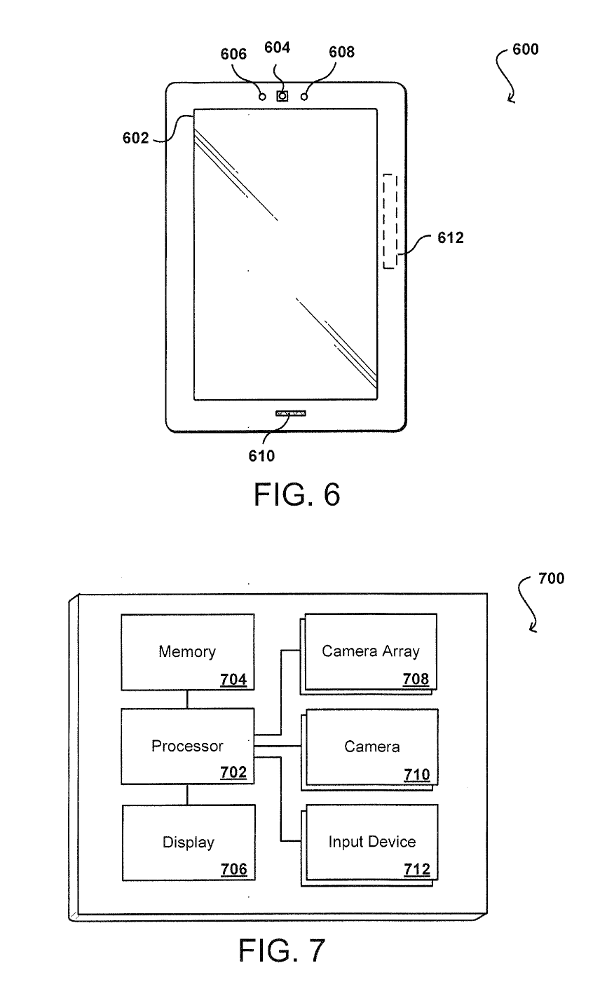

FIG. 7 illustrates a logical arrangement of a set of general components of an example computing device 700 such as the device 600 described with respect to FIG. 6. In this example, the device includes a processor 702 for executing instructions that can be stored in a memory device or element 704. As would be apparent to one of ordinary skill in the art, the device can include many types of memory, data storage, or non-transitory computer-readable storage media, such as a first data storage for program instructions for execution by the processor 702, a separate storage for images or data, a removable memory for sharing information with other devices, etc. The device typically will include some type of display element 706, such as a touch screen or liquid crystal display (LCD), although devices such as portable media players might convey information via other means, such as through audio speakers. As discussed, the device in many embodiments will include at least one conventional image capture element 710 such as a camera or infrared sensor that is able to capture images of objects in the vicinity of the device. The device can also include at least one camera array 708 as discussed herein, which can include a plurality of detectors and emitters in various embodiments. Methods for capturing images or video using a camera element with a computing device are well known in the art and will not be discussed herein in detail. It should be understood that image capture can be performed using a single image, multiple images, periodic imaging, continuous image capturing, image streaming, etc. Further, a device can include the ability to start and/or stop image capture, such as when receiving a command from a user, application, or other device. The example device can include at least one mono or stereo microphone or microphone array, operable to capture audio information from at least one primary direction. A microphone can be a uni- or omni-directional microphone as known for such devices.

In some embodiments, the computing device 700 of FIG. 7 can include one or more communication components, such as a Wi-Fi, Bluetooth, RF, wired, or wireless communication system. The device in many embodiments can communicate with a network, such as the Internet, and may be able to communicate with other such devices. In some embodiments the device can include at least one additional input element 712 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device.

The device also can include at least one orientation or motion sensor. As discussed, such a sensor can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The device can include other elements as well, such as may enable location determinations through triangulation or another such approach. These mechanisms can communicate with the processor, whereby the device can perform any of a number of actions described or suggested herein.

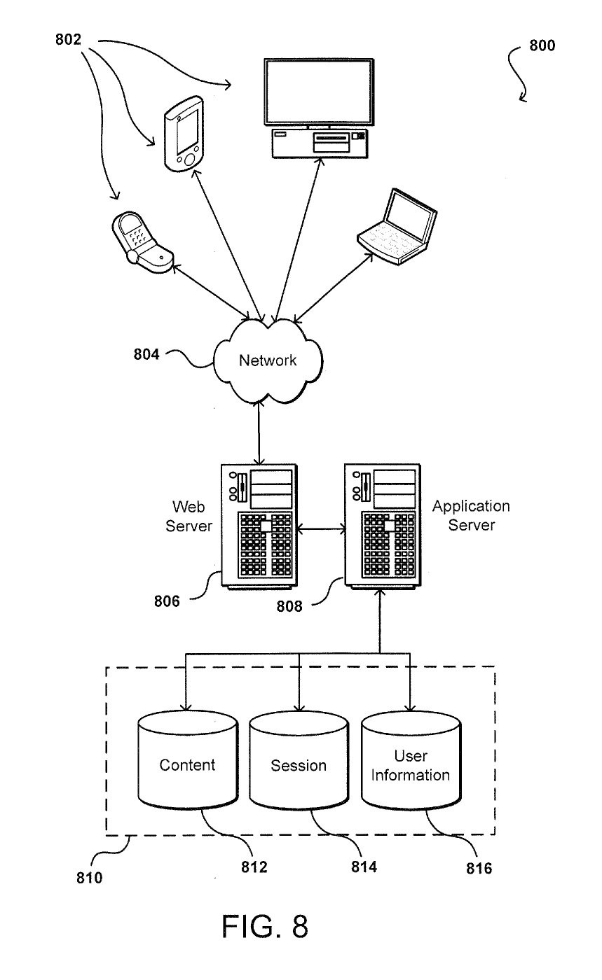

As discussed, different approaches can be implemented in various environments in accordance with the described embodiments. For example, FIG. 8 illustrates an example of an environment 800 for implementing aspects in accordance with various embodiments. As will be appreciated, although a Web-based environment is used for purposes of explanation, different environments may be used, as appropriate, to implement various embodiments. The system includes an electronic client device 802, which can include any appropriate device operable to send and receive requests, messages or information over an appropriate network 804 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 806 for receiving requests and serving content in response thereto, although for other networks, an alternative device serving a similar purpose could be used, as would be apparent to one of ordinary skill in the art.

The illustrative environment includes at least one application server 808 and a data store 810. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 808 can include any appropriate hardware and software for integrating with the data store 810 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 806 in the form of HTML, XML or another appropriate structured language in this example. The handling of all requests and responses, as well as the delivery of content between the client device 802 and the application server 808, can be handled by the Web server 806. It should be understood that the Web and application servers are not required and are merely example components, as structured code discussed herein can be executed on any appropriate device or host machine as discussed elsewhere herein.

The data store 810 can include several separate data tables, databases or other data storage mechanisms and media for storing data relating to a particular aspect. For example, the data store illustrated includes mechanisms for storing content (e.g., production data) 812 and user information 816, which can be used to serve content for the production side. The data store is also shown to include a mechanism for storing log or session data 814. It should be understood that there can be many other aspects that may need to be stored in the data store, such as page image information and access rights information, which can be stored in any of the above listed mechanisms as appropriate or in additional mechanisms in the data store 810. The data store 810 is operable, through logic associated therewith, to receive instructions from the application server 808 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 802. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the system 800 in FIG. 8 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A computing device, comprising:
at least one processor;
a display screen including at least a transmissive layer for displaying content, the content being viewable on the computing device from a first side of the display screen;
a detector array positioned proximate a second side of the display screen, the second side being opposite the first side, the detector array including a plurality of photodiodes each configured to capture infrared (IR) light incident on the first side of the display screen and passing through at least the transmissive layer;
a plurality of infrared emitters configured to emit IR light; and
memory including instructions that, when executed by the at least one processor, cause the computing device to:
cause at least two of the infrared emitters to emit light at different specified times;
collect intensity data captured by the detector array for each of the specified times, the intensity data corresponding to IR light emitted by at least one of the IR emitters and reflected by an object that is located within a determinable range of the computing device;
generate a combined data set including the intensity data for each of the specified times, the combined data set including at least combined intensity data for each of the photodiodes in the detector array; and
analyze the representation of the object in the combined data set to determine at least one of a location and an orientation of the object with respect to the computing device.

2. The computing device of claim 1, wherein the at least two infrared emitters are positioned proximate different edges of the detector array, wherein the representation of the object in the intensity data for each of the specified times will represent illumination from a respective direction.

3. The computing device of claim 1, wherein the at least two infrared emitters are on a common substrate with the photodiodes of the detector array, and wherein the at least two infrared emitters are positioned proximate to at least one of the corners or edges of the common substrate.

4. The computing device of claim 1, further comprising:
at least one camera positioned at a distance from the display screen, the at least one camera configured to capture images capable of being analyzed by the at least one processor to determine at least one of a location or an orientation of the object when the object is within a field of view of the at least one camera, the detector array configured to capture intensity data capable of being analyzed to determine at least one of the location or the orientation of the object when the object is outside the field of view of the at least one camera but within the determinable range of the computing device.

5. A computing device, comprising:
a processor;
a display screen for displaying content;
a detector array including a plurality of detectors each configured to detect light that is reflected by an object and passes through the display screen; and
memory including instructions that, when executed by the processor, cause the computing device to analyze data for the light detected by the detector array to determine a position of the object with respect to the computing device.

6. The computing device of claim 5, wherein the detectors are photodiodes separated by at least a determined distance on a substrate, the substrate including lines for connecting the photodiodes to circuitry operable to read values detected by each of the photodiodes.

7. The computing device of claim 5, further comprising:
at least one illumination source operable to provide a source of illumination for causing light to be reflected from the object through the display screen.

8. The computing device of claim 7, wherein the at least one illumination source includes at least one infrared light emitting diode configured to emit infrared radiation through the display screen, the detectors capable of detecting at least a portion of the infrared radiation reflected by the object and passing back through the display screen.

9. The computing device of claim 7, wherein the at least one illumination source includes a backlight for the display screen.

10. The computing device of claim 7, further comprising:
an infrared-transmissive element positioned between the display screen and a substrate supporting the at least one illumination source and the detector array, the infrared-transmissive element preventing visible light from being detected by the detector array.

11. The computing device of claim 7, wherein the at least two illumination sources are activated to emit light at different specified times from different directions.

12. The computing device of claim 11, wherein the instructions when executed further cause the computing device to:
collect intensity data captured by the detector array for each of the specified times, the intensity data including intensity data for light emitted by at least one of the at least two illumination sources and reflected by the object;
generate a combined data set including the intensity data for each of the specified times, the combined data set including at least combined intensity information for each of the detectors in the detector; and
analyze the representation of the object in the combined data set to further determine an orientation of the object with respect to the computing device.

13. The computing device of claim 5, further comprising:
at least one camera positioned on the computing device at a distance from the display screen, the at least one camera configured to capture images capable of being analyzed by the processor to determine at least one of a location or an orientation of the object when the object is within a field of view of the at least one camera, the detector array configured to capture image data capable of being analyzed to determine at least one of the location or the orientation of the object when the object is outside the field of view of the at least one camera.

14. The computing device of claim 5, wherein the instructions when executed further cause the detector array to detect light between successive active periods of the display screen.

15. The computing device of claim 5, wherein the active layer includes a liquid crystal material, and wherein the liquid crystal material is configured to he activated to enable at least a portion of the light incident on the display screen to pass through the display screen.

16. The computing device of claim 5, wherein the instructions when executed further cause the computing device to track the object over time, enabling the computing device to determine at least one of a motion or a gesture performed by the object.

17. The computing device of claim 5, wherein the object includes at least one of a finger or hand of the user, or an object held by the user.

18. A computer-implemented method, comprising:
causing at least two emitters to emit light at different specified times, the emitters configured to emit the light through a display screen of a computing device;
collect intensity data captured by a detector array for each of the specified times, the intensity data corresponding to light emitted by at least one of the emitters and reflected by an object within at least a detection range of the computing device, the light reflected by the object passing back through the display screen before being detected by the detector array;
generate a combined data set including the intensity data for each of the specified times, the combined data set including at least combined intensity data for each detector in the detector array; and
analyze the representation of the object in the combined data set to determine at least one of a location and an orientation of the object with respect to the computing device.

19. The computer-implemented method of claim 18, wherein the instructions when executed further cause the computing device to track the object over time, enabling the computing device to determine at least one of a motion or a gesture performed by the object.

20. The computer-implemented method of claim 18, wherein the emitters emit infrared light and the detectors of the detector array detect reflected portions of the infrared light emitted by the emitters, and wherein the infrared light is capable of being detected during operation of the display screen.

21. The computer-implemented method of claim 18, wherein the computing device includes at least one camera positioned at a distance from the display screen, the at least one camera configured to capture images capable of being analyzed to determine at least one of a location or an orientation of the object when the object is within a field of view of the at least one camera, the detector array configured to capture image data capable of being analyzed to determine at least one of the location or the orientation of the object when the object is outside the field of view of the at least one camera and within the detection range.

22. A non-transitory computer-readable storage medium including instructions that, when executed by at least one processor of a computing device, cause the computing device to:
detect light using a plurality of photodiodes, the light being reflected by an object and passing through a display screen of the computing device;
generate a data set for the light detected by the plurality of photodiodes based at least n part upon a location of each of the photodiodes and an intensity of light detected by each of the photodiodes;
analyze the data set to determine a location of a representation of the object in the data set; and
determine a location of the object with respect to the computing device based at least in part upon the location of the representation of the object in the data set.

23. The non-transitory computer-readable storage medium of claim 22, wherein the instructions when executed further cause the computing device to:
emit light using at least one emitter of the computing device, the emitter configured to emit the light such that a portion of the light reflected by the object is capable of being detected by one or more of the plurality of photodiodes.

24. The non-transitory computer-readable storage medium of claim 23, wherein the instructions when executed further cause the computing device to:
cause at least two emitters of the computing device to emit light at different specified times;
obtain intensity data for light detected by the plurality of photodiodes for each of the specified times, the intensity data corresponding to light emitted by at least one of the emitters and reflected by an object within at least a detection range of the computing device, the light reflected by the object passing back through the display screen before being detected by the plurality of photodiodes;
generate a combined data set including the intensity data for each of the specified times, the combined data set including at least combined intensity data for each photodiode; and
analyze the representation of the object in the combined data set to determine at least an orientation of the object with respect to the computing device,

25. The non-transitory computer-readable storage medium of claim 22, wherein the instructions when executed further cause the computing device to track the object over time, enabling the computing device to determine at least one of a motion or a gesture performed by the object.
